(19) United States
(12) Patent Application Publication
(10) Pub. No.: US 2017/0101560 A1
(43) Pub. Date: Apr. 13, 2017

(54) PRESSURE SENSITIVE ADHESIVE COMPOSITION, PRESSURE SENSITIVE ADHESIVE SHEET, PRESSURE SENSITIVE ADHESIVE FILM, LAMINATE FOR TOUCH PANEL, AND CAPACITIVE TOUCH PANEL

(71) Applicant: FUJIFILM Corporation, Tokyo (JP)

(72) Inventors: Tetsuro MITSUI, Ashigara-kami-gun (JP); Yohei ISHIJI, Ashigara-kami-gun (JP)

(73) Assignee: FUJIFILM Corporation, Tokyo (JP)

(21) Appl. No.: 15/389,734

(22) Filed: Dec. 23, 2016

Related U.S. Application Data
(63) Continuation of application No. PCT/JP2015/067499, filed on Jun. 17, 2015.

(30) Foreign Application Priority Data
Jun. 27, 2014 (JP) 2014-133207

(51) Int. Cl. C09J 133/04; C09J 109/00; G06F 3/044; C09J 139/06

(52) U.S. Cl. CPC C09J 133/04; C09J 139/06; C09J 109/00; G06F 3/044; G06F 2203/04103

(57) ABSTRACT

The present invention provides a pressure sensitive adhesive composition capable of forming a pressure sensitive adhesive sheet which has excellent adhesiveness and a low relative permittivity and causes less change in the relative permittivity according to environmental temperatures, a pressure sensitive adhesive sheet, a pressure sensitive adhesive film, a laminate for a touch panel including the pressure sensitive adhesive sheet, and a capacitive touch panel.

The pressure sensitive adhesive composition of the present invention includes: a component selected from the group consisting of a polymer obtained by polymerizing a monomer component including 5 to 75 mass % of a monomer having a nitrogen atom-containing cyclic structure and 25 to 80 mass % of a (meth)acrylic monomer having an alkyl group with 3 to 22 carbon atoms at an ester end, a product of partial polymerization of the monomer component, and the monomer component; and at least one rubber component selected from the group consisting of polyisoprene, polyisobutylene, and polybutadiene, in which the content of the rubber component is 1 to 50 mass % with respect to a total solid content.

### CROSS-REFERENCE TO RELATED APPLICATIONS

This application is a Continuation of PCT International Application No. PCT/JP2015/067499 filed on Jun. 17, 2015, which claims priority under 35 U.S.C. §119(a) to Japanese Patent Application No. 2014-133207 filed on Jun. 27, 2014. The above application is hereby expressly incorporated by reference, in its entirety, into the present application.

### BACKGROUND OF THE INVENTION

1. Field of the Invention

The present invention relates to a pressure sensitive adhesive composition, a pressure sensitive adhesive sheet, a pressure sensitive adhesive film, a laminate for a touch panel, and a capacitive touch panel.

2. Description of the Related Art

In recent years, the proportion of mobile phones, portable game devices, and the like into which touch panels built has increased. For example, capacitive touch panels (hereinafter, simply referred to as touch panels) which enable multi-point detection have attracted attention.

Typically, when a touch panel is produced, a pressure sensitive adhesive composition is used to cause members such as a display device and a touch panel sensor to come into close contact with each other. In addition, such a composition is often used by being formed into a sheet shape.

For example, JP2013-032500A discloses a pressure sensitive adhesive sheet formed from a “pressure sensitive adhesive composition including a (meth)acrylic polymer obtained by polymerizing a monomer component including 25 wt % to 99.5 wt % of a monomer including a cyclic structure and 0.5 wt % to 70 wt % of a (meth)acrylic monomer including a branched structure having an alkyl group with 3 to 18 carbon atoms at an ester end.

### SUMMARY OF THE INVENTION

On the other hand, a pressure sensitive adhesive sheet requires various characteristics to be used in a touch panel. For example, in terms of the durability of a touch panel, excellent adhesiveness is required. In addition, in terms of the prevention of touch panel malfunction, the pressure sensitive adhesive sheet requires a low relative permittivity. Furthermore, since the touch panel is used in various usage environments such as cold regions and warm regions, it is preferable that the relative permittivity of the pressure sensitive adhesive sheet does not change according to the environmental temperature in order to prevent malfunction of the touch panel in such environments. In other words, it is preferable that the temperature dependence of the relative permittivity is low. When the relative permittivity of the pressure sensitive adhesive sheet significantly changes according to temperatures, the capacitance between detection electrodes changes and is likely to deviate from an initially set value, which leads to malfunction.

That is, the pressure sensitive adhesive sheet requires excellent adhesiveness (high adhesiveness), a low relative permittivity (low permittivity), and low temperature dependence for the relative permittivity (low temperature dependence).

The pressure sensitive adhesive sheet of JP2013-032500A does not sufficiently satisfy the above-described characteristics (high adhesiveness, low permittivity, and low temperature dependence) at the same time. Therefore, a further improvement is necessary.

In consideration of the above-described circumstances, an object of the present invention is to provide a pressure sensitive adhesive composition capable of forming a pressure sensitive adhesive sheet which has excellent adhesiveness and a low relative permittivity and causes less change in the relative permittivity according to environmental temperatures.

In addition, another object of the present invention is to provide a pressure sensitive adhesive sheet, a pressure sensitive adhesive film, a laminate for a touch panel including the pressure sensitive adhesive sheet, and a capacitive touch panel.

The inventors have conducted intensive research on the above-described problems. As a result, it was found that the above-described problems can be solved by using a predetermined monomer and a predetermined rubber component, and the present invention was completed.

That is, the inventors found that the above-described problems can be solved by the following configuration.

(1) A pressure sensitive adhesive composition comprising: a component selected from the group consisting of a polymer obtained by polymerizing a monomer component including 5 to 75 mass % of a monomer having a nitrogen atom-containing cyclic structure and 25 to 80 mass % of a (meth)acrylic monomer having an alkyl group with 3 to 22 carbon atoms at an ester end, a product of partial polymerization of the monomer component, and the monomer component; and at least one rubber component selected from the group consisting of polyisoprene, polyisobutylene, and polybutadiene, in which the content of the rubber component is 1 to 50 mass % with respect to a total solid content.

(2) The pressure sensitive adhesive composition described in (1), in which the alkyl group is linear or branched.

(3) The pressure sensitive adhesive composition described in (1) or (2), in which the (meth)acrylic monomer includes a (meth)acrylic monomer having a linear alkyl group with 10 to 22 carbon atoms at an ester end.

(4) The pressure sensitive adhesive composition described in any one of (1) to (3), in which the (meth)acrylic monomer includes a (meth)acrylic monomer having a branched alkyl group with 3 to 9 carbon atoms at an ester end, and a (meth)acrylic monomer having a linear alkyl group with 10 to 22 carbon atoms at an ester end.

(5) The pressure sensitive adhesive composition described in any one of (1) to (4), in which the rubber component includes two different types of rubber component.

(6) The pressure sensitive adhesive composition described in any one of (1) to (5), further comprising: a viscosity imparting agent.

(7) The pressure sensitive adhesive composition described in any one of (1) to (6), in which the number of ring members of the monomer having the nitrogen atom-containing cyclic structure is 5 to 8.

(8) The pressure sensitive adhesive composition described in any one of (1) to (7), in which the rubber component includes a rubber having a cross-linking group.

(9) The pressure sensitive adhesive composition described in any one of (1) to (8), further comprising: a polyfunctional monomer.

(10) A pressure sensitive adhesive sheet formed by using the pressure sensitive adhesive composition described in any one of (1) to (9).

(11) A pressure sensitive adhesive sheet comprising: a polymer obtained by polymerizing a monomer component including 5 to 75 mass % of a monomer having a nitrogen atom-containing cyclic structure and 25 to 75 mass % of a (meth)acrylic monomer having an alkyl group with 3 to 22 carbon atoms at an ester end; and at least one rubber component selected from the group consisting of polyisoprene, polyisobutylene, and polybutadiene, in which the content of the rubber component is 1 to 50 mass % with respect to a total mass of the pressure sensitive adhesive sheet.

(12) The pressure sensitive adhesive sheet described in (11), in which the alkyl group is linear or branched.

(13) The pressure sensitive adhesive sheet described in (11) or (12), in which the (meth)acrylic monomer includes a (meth)acrylic monomer having a linear alkyl group with 10 to 22 carbon atoms at an ester end.

(14) The pressure sensitive adhesive sheet described in any one of (11) to (13), in which the (meth)acrylic monomer includes a (meth)acrylic monomer having a branched alkyl group with 3 to 9 carbon atoms at an ester end, and a (meth)acrylic monomer having a linear alkyl group with 10 to 22 carbon atoms at an ester end.

(15) The pressure sensitive adhesive sheet described in any one of (11) to (14), in which the rubber component includes two different types of rubber component.

(16) The pressure sensitive adhesive sheet described in any one of (11) to (15), further comprising: a viscosity imparting agent.

(17) The pressure sensitive adhesive sheet described in any one of (11) to (16), in which the number of ring members of the monomer having the nitrogen atom-containing cyclic structure is 5 to 8.

(18) The pressure sensitive adhesive sheet described in any one of (11) to (17), in which a gel fraction is 30 to 75 mass %.

(19) A pressure sensitive adhesive film comprising: the pressure sensitive adhesive sheet according to those described in any one of (10) to (18); and a peelable sheet disposed on at least one surface of the pressure sensitive adhesive sheet.

(20) A laminate for a touch panel comprising: the pressure sensitive adhesive sheet described in any one of (10) to (18); and a capacitive touch panel sensor.

(21) The laminate for a touch panel described in (20), further comprising: a protective substrate, in which the protective substrate, the pressure sensitive adhesive sheet, and the capacitive touch panel sensor are provided in this order.

(22) A capacitive touch panel comprising: a capacitive touch panel sensor, the pressure sensitive adhesive sheet described in any one of (10) to (18), and a display device in this order.

According to the present invention, a pressure sensitive adhesive composition capable of forming a pressure sensitive adhesive sheet which has excellent adhesiveness and a low relative permittivity and in which less change in the relative permittivity according to environmental temperature is caused, can be provided.

In addition, according to the present invention, a pressure sensitive adhesive sheet, a pressure sensitive adhesive film, a laminate for a touch panel including the pressure sensitive adhesive sheet, and a capacitive touch panel can also be provided.

### BRIEF DESCRIPTION OF THE DRAWINGS

FIG. 1 is a schematic view of a sample for evaluation used in a temperature dependence evaluation test.

FIG. 2 shows an example of results of the temperature dependence evaluation test.

FIG. 3 is a cross-sectional view of an aspect of a laminate for a touch panel of the present invention.

FIG. 4 is a cross-sectional view of another aspect of the laminate for a touch panel of the present invention.

FIGS. 5A and 5B are cross-sectional views of a capacitive touch panel of the present invention.

### DESCRIPTION OF THE PREFERRED EMBODIMENTS

Hereinafter, a pressure sensitive adhesive composition, a pressure sensitive adhesive sheet, a pressure sensitive adhesive film, a laminate for a touch panel, and a capacitive touch panel of the present invention will be described. In the specification, a numerical value range expressed by using “to” means a range including numerical values shown before and after “to” as the lower limit and the upper limit. In addition, a (meth)acryloyl group is a concept including an acryloyl group and a methacryloyl group.

The feature of the present invention is that a polymer obtained by polymerizing a predetermined monomer component, a product of partial polymerization of the monomer component, or the monomer component, and a predetermined rubber component are used. The adhesion of the pressure sensitive adhesive sheet can be primarily increased by selecting a predetermine monomer, and a low permittivity and low temperature dependence are realized by using the predetermined rubber component.

Hereinafter, first, components of the pressure sensitive adhesive composition will be described in detail, and the pressure sensitive adhesive sheet will be thereafter described in detail.

<Pressure Sensitive Adhesive Composition>

The pressure sensitive adhesive composition (hereinafter, sometimes simply referred to as “composition”) includes: a component selected from the group consisting of a polymer obtained by polymerizing a monomer component including 5 to 75 mass % of a monomer having a nitrogen atom-containing cyclic structure and 25 to 80 mass % of a (meth)acrylic monomer having an alkyl group with 3 to 22 carbon atoms at an ester end, a product of partial polymerization of the monomer component, and the monomer component; and at least one rubber component selected from the group consisting of polyisoprene, polyisobutylene, and polybutadiene.

Hereinafter, the components included in the pressure sensitive adhesive composition will be described in detail.

[Polymer, Product of Partial Polymerization, or Monomer Component]

The composition includes the component (hereinafter, sometimes simply referred to as “component X”) selected from the group consisting of the polymer obtained by polymerizing the predetermined monomer component, the product of partial polymerization of the monomer component, and the monomer component. That is, any of the three types of the polymer, the product of partial polymerization of the monomer component, and the monomer component is used. In addition, the “product of partial polymerization of the monomer component” means a component obtained by partially polymerizing the monomer component. That is, for example, a product of partial polymerization (polymer syrup) obtained by partially polymerizing the monomer component through irradiation of the monomer component with ultraviolet rays (UV) may be employed. In addition, by further polymerizing the product of partial polymerization of the monomer component, the polymer can be obtained.

As the monomer component, at least the monomer having the nitrogen atom-containing cyclic structure, and the (meth)acrylic monomer having an alkyl group with 3 to 22 carbon atoms at an ester end are used.

Hereinafter, first, the monomer component that is used will be described in detail.

(Monomer Having Nitrogen Atom-Containing Cyclic Structure)

The monomer (hereinafter, sometimes simply referred to as “monomer X”) having the nitrogen atom-containing cyclic structure is a monomer having a cyclic structure including nitrogen atoms.

The monomer X includes a polymerizable functional group. The type of the polymerizable functional group is not particularly limited, and may employ a radical polymerizable group or a cationic polymerizable group. A polymerizable functional group having an unsaturated double bond such as a (meth)acryloyl group or a vinyl group.

The monomer X includes the nitrogen atom-containing cyclic structure. This structure is a cyclic structure including at least nitrogen atoms as atoms included as members of a ring. The number of rig members of the nitrogen atom-containing cyclic structure is not particularly limited, but is preferably 5 to 8, and more preferably 5 to 7 in terms of satisfying at least one of more excellent adhesiveness of the pressure sensitive adhesive sheet, a lower relative permittivity of the pressure sensitive adhesive sheet, or lower temperature dependence of the relative permittivity of the pressure sensitive adhesive sheet (hereinafter, sometimes simply referred to as “in terms of more excellent effects of the present invention”). In addition, the number of nitrogen atoms included in the nitrogen atom-containing cyclic structure is not particularly limited, but is preferably 1 to 3 and more preferably 1. In addition, as atoms included in the nitrogen atom-containing cyclic structure, in addition to the nitrogen atoms, carbon atoms or heteroatoms other than the nitrogen atoms may be employed.

In terms of more excellent effects of the present invention, it is preferable that the nitrogen atom-containing cyclic structure includes an amide bond (—CONH—).

As a suitable aspect of the nitrogen atom-containing cyclic structure, a structure represented by the following Formula (A) may be employed.

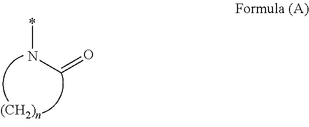 [SMILES: *NC=O]

In Formula (A), n presents an integer of 3 to 5. Among the integers, 3 or 4 is preferable. * represents a bonding position.

In terms of more excellent effects of the present invention, as a suitable aspect of the monomer X, a monomer represented by the following Formula (B).

CH₂═CR¹—R² Formula (B)

In Formula (B), R¹ represents a hydrogen atom or an alkyl group. R² represents the nitrogen atom-containing cyclic structure.

As the monomer X, N-vinylpyrrolidone, N-vinylcaprolactam, vinylimidazole, vinylpyridine, and the like may be employed.

In addition, as the monomer X, only one type may be used, and two or more types may be used in combination.

The content of the monomer X in the monomer component is 5 to 75 mass % with respect to the total mass of the monomer component, and in terms of more excellent effects of the present invention, is preferably 5 to 50 mass %, and more preferably 5 to 35 mass %.

In a case where the content is less than 5 mass %, the adhesiveness of the pressure sensitive adhesive sheet deteriorates. In a case where the content is more than 75 mass %, the permittivity of the pressure sensitive adhesive sheet and/or the temperature dependence of the permittivity deteriorates.

((Meth)acrylic Monomer Having Alkyl Group with 3 to 22 Carbon Atoms at Ester End)

The (meth)acrylic monomer (hereinafter, sometimes simply referred to as “monomer Y”) having an alkyl group with 3 to 22 carbon atoms at an ester end means a monomer represented by the following Formula (C).

CH₂═CR³COO—R⁴ Formula (C)

In Formula (C), R³ represents a hydrogen atom or a methyl group. IV represents an alkyl group with 3 to 22 carbon atoms.

The number of carbon atoms included in the alkyl group of the monomer Y is 3 to 22, and is preferably 8 to 22 and more preferably 15 to 22 in terms of more excellent effects of the present invention.

The alkyl group may be linear, branched, or cyclic, and is preferably linear or branched.

Examples of the monomer Y include hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, n-hexadecyl (meth)acrylate, stearyl (meth)acrylate, isobornyl (meth)acrylate, dicyclopentenyl (meth)acrylate, and dicyclopentanyl (meth)acrylate.

In terms of more excellent effects of the present invention, as a suitable aspect of the monomer Y, a (meth)acrylic monomer having a linear alkyl group with 10 to 22 carbon atoms at an ester end may be employed.

In addition, as another suitable aspect of the monomer Y, a (meth)acrylic monomer having a branched alkyl group with 3 to 9 carbon atoms at an ester end may be employed.

In addition, as the monomer Y, only one type may be used, and two or more types may be used in combination. For example, in a case of a combination of two or more types, an aspect of a combination of the (meth)acrylic monomer having a linear alkyl group with 10 to 22 carbon atoms at an ester end and the (meth)acrylic monomer having a branched alkyl group with 3 to 9 carbon atoms at an ester end may be employed.

The content of the monomer Y in the monomer component is 25 to 80 mass % with respect to the total mass of the monomer component, and in terms of more excellent effects of the present invention, is preferably 30 to 80 mass %, and more preferably 40 to 75 mass %.

In a case where the content is less than 25 mass %, the permittivity of the pressure sensitive adhesive sheet and/or the temperature dependence of the permittivity deteriorates. In a case where the amount is more than 80 mass %, the adhesiveness of the pressure sensitive adhesive sheet deteriorates.

(Other Monomers)

In the monomer component, monomers other than the monomer X and the monomer Y may also be used.

As other monomers, a monomer including a carboxyl group, a monomer including a hydroxyl group, a monomer having a cyclic ether group, and the like may be employed.

Specific examples of other monomers include a (meth)acrylic acid, benzyl (meth)acrylate, phenoxyethyl (meth)acryl ate, butoxyethylene glycol (meth)acrylate, butoxydiethylene glycol (meth)acrylate, methoxytriethylene glycol (meth)acryl ate, cyclohexyl (meth)acrylate, tetrahydrofurfuryl (meth)acrylate, 2-hydroxyethyl (meth)acrylate, 3-hydroxypropyl (meth)acrylate, 4-hydroxybutyl (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol methyl ether (meth)acrylate, heptapropylene glycol monomethyl ether (meth)acrylate, tetraethylene glycol ethyl ether (meth)acrylate, tetraethylene glycol mono(meth)acrylate, hexaethylene glycol mono(meth)acrylate, octapropylene glycol mono(meth)acrylate, glycidyl (meth)acrylate, 4-hydroxybutyl (meth)acrylate glycidyl ether, 3,4-epoxycyclohexyl methyl (meth)acrylate, N,N-dimethyl (meth)acrylamide, N,N-diethyl (meth)acrylamide, N-t-butyl (meth)acryl amide, INN-isopropyl (meth)acrylamide, N-t-octyl (meth)acrylamide, N,N-dimethylaminoethyl (meth)acrylamide, N,N-dimethylaminopropyl (meth)acrylamide, diacetone acrylamide, (meth)acryloyl morpholine, and N-acryloyloxyethyl hexahydrophthalimide.

In addition, the monomer component does not include a cross-linking agent (for example, polyfunctional monomer), which will be described later, and a rubber having a cross-linking group.

A production method of the polymer using the above-described monomer component is not particularly limited, and for example, a well-known production method such as solution polymerization, radiation polymerization such as UV polymerization, bulk polymerization, or emulsion polymerization may be appropriately selected. In addition, the obtained polymer may be any of a random copolymer, a block copolymer, and a graft copolymer.

Hereinafter, solution polymerization and radiation polymerization as the production method of the polymer will be described in detail.

In the solution polymerization, as a polymerization solvent, for example, ethyl acetate, or toluene is used. As a specific example of the solution polymerization, solution polymerization is carried out by adding a polymerization initiator in a stream of inert gas such as nitrogen gas typically under reaction conditions of about 50° C. to 70° C. and 5 to 30 hours.

Examples of a thermal polymerization initiator used for solution polymerization or the like include an azo-based initiator, a peroxide-based initiator, a redox-based initiator formed by a combination of a peroxide and a reducing agent, such as a combination of a persulfate and sodium bisulfite and a combination of a peroxide and sodium ascorbate. The amount of the thermal polymerization initiator used is not particularly limited, and for example, is preferably 0.005 to 1 parts by mass with respect to 100 parts by mass of the monomer component.

In a case where the polymer is produced through radiation polymerization, the polymer may be produced by polymerizing the monomer component through irradiation with radiation such as electron beams and ultraviolet rays.

A photopolymerization initiator is preferably used for the radiation polymerization. The photopolymerization initiator is not particularly limited as long as the photopolymerization initiator initiates photopolymerization, and a photopolymerization initiator that is typically used may be used. For example, a benzoinether-based photopolymerization initiator, an acetophenone-based photopolymerization initiator, α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, a thioxanthone-based photopolymerization initiator, an acylphosphine oxide-based photopolymerization initiator, and the like may be used. The amount of the photopolymerization initiator used is not particularly limited, and for example, is preferably 0.01 to 5 parts by mass with respect to 100 parts by mass of the monomer component.

The weight-average molecular weight of the polymer is not particularly limited, and is preferably 400,000 to 2,500,000, and more preferably 600,000 to 2,200,000 in terms of more excellent effects of the present invention.

In addition, the weight-average molecular weight of the polymer is measured through gel permeation chromatography (GPC). As a sample, a filtrate obtained by dissolving a specimen in tetrahydrofuran to make a 0.1 mass % solution, leaving the solution one day, and thereafter filtering the solution with a membrane filter having a 0.45 μm pore size, is used.

The product of partial polymerization of the monomer component is a product of partial polymerization formed from the monomer component. The product of partial polymerization can be formed into a polymer through the above-described polymerization method (for example, radiation polymerization (specifically, UV irradiation) or the like). More specifically, in this embodiment, a product of partial polymerization (polymer syrup) in which the monomer component is partially polymerized may be prepared by irradiating the monomer component with ultraviolet rays (UV), the pressure sensitive adhesive composition may be prepared by mixing the polymer syrup with a rubber component, which will be described later, and the pressure sensitive adhesive composition may be applied to a predetermined application object and is irradiated with ultraviolet rays, thereby completing the polymerization.

The polymerization rate of the monomer component of the product of partial polymerization is preferably 5 to 40 mass %, and more preferably 5 to 20 mass % in terms of an appropriate viscosity for handling and application of the pressure sensitive adhesive composition of the present invention.

The polymerization rate is obtained as follows.

A portion of the product of partial polymerization is sampled to produce a specimen. The specimen is accurately weighed to obtain the mass thereof, which is referred to as the “mass of the product of partial polymerization before drying”. Next, the specimen is dried at 130° C. for 2 hours, and the specimen after the drying is accurately weighed to obtain the mass thereof, which is referred to as the “mass of the product of partial polymerization after drying”. In addition, from the “mass of the product of partial polymerization before drying” and the “mass of the product of partial polymerization after drying”, a reduction in the mass of the specimen due to the drying at 130° C. for 2 hours is obtained and is referred to as “mass reduction amount” (volatilized content and unreacted monomer mass). From the obtained “mass of the product of partial polymerization before drying” and the “mass reduction amount”, the polymerization rate (mass %) of the product of partial polymerization of the monomer component is obtained from the following Formula.

Polymerization rate of product of partial polymerization of monomer component (mass %)=[1−(mass reduction amount)/(mass of product of partial polymerization before drying)]×100

The content of the component X in the composition is not particularly limited, and is preferably 5 to 95 mass %, and more preferably 15 to 90 mass % with respect to the total solid content of the composition in terms of more excellent effects of the present invention.

In addition, the solid content means components (components forming the pressure sensitive adhesive sheet) excluding volatile components such as a solvent.

[Rubber Component]

As the rubber component, at least one selected from the group consisting of polyisoprene, polyisobutylene, and polybutadiene may be employed. Among these, two or more different types are preferably used in terms of more excellent effects of the present invention.

The rubber component may include a cross-linking group such as a (meth)acryloyl group or a polar group. That is, a rubber having a cross-linking group, which will be described later, is included in the rubber component.

As the rubber component, a combination of the rubber having a cross-linking group and a rubber that does not have a cross-linking group may also be used.

The rubber having a cross-linking group is a rubber component having a functional group that can allow a cross-linking reaction with another functional group to proceed. The inclusion of the rubber in the composition contributes to more excellent adhesiveness of the pressure sensitive adhesive sheet and reductions in the relative permittivity of the pressure sensitive adhesive sheet and the temperature dependence of the relative permittivity.

The type of the cross-linking group is not particularly limited, and well-known cross-linking groups (for example, a hydroxyl group, an isocyanate group, and an epoxy group) may be employed. Among these, a polymerizable group is preferable in terms of reactivity. As the polymerizable group, well-known radical polymerizable groups (a (meth)acryloyl group, an acrylamide group, a vinyl group, a styryl group, an allyl group, and the like) or well-known cationic polymerizable groups (an epoxy group and the like) may be employed.

Among these, in terms of more excellent effects of the present invention, as the rubber having a cross-linking group, at least one selected from the group consisting of polybutadiene, polyisoprene, and polyisobutylene, and has a (meth)acryloyl group may be employed. For example, as polyisoprene (meth)acrylate, “UC-102” (molecular weight 17,000) and “UC-203” (molecular weight 35,000) manufactured by Kuraray Co., Ltd. may be employed, and as polybutadiene (meth)acrylate, “TEAI-1000” (molecular weight 2,000), “TE-2000” (molecular weight 2,500), and “EMA-3000” (molecular weight 3,100) manufactured by Nippon Soda Co., Ltd. may be employed.

The content of the rubber component in the composition is 1 to 50 mass % with respect to the total solid content of the composition, and in terms of more excellent effects of the present invention, is preferably 5 to 40 mass %, and more preferably 5 to 30 mass %.

In a case where the content is less than 1 mass %, the permittivity of the pressure sensitive adhesive sheet or the temperature dependence of the permittivity deteriorates. In a case where the content is more than 50 mass %, the adhesiveness of the pressure sensitive adhesive sheet deteriorates.

[Other Components]

The composition may include components other than the component X and the rubber component. For example, there are a viscosity imparting agent, a cross-linking agent, and a solvent. Hereinafter, each component will be described in detail.

(Viscosity Imparting Agent)

A viscosity imparting agent imparts viscosity, and as the viscosity imparting agent is included in the composition, the adhesiveness of the pressure sensitive adhesive sheet becomes more excellent.

As the viscosity imparting agent, a well-known agent in the patch and patch preparation fields may be appropriately selected to be used. As the viscosity imparting agent, a viscosity imparting resin may be employed. Examples thereof include: a rosin-based resin such as a rosin ester, a hydrogenated rosin ester, a disproportionated rosin ester, and a polymerized rosin ester; coumarone indene-based resin such as a coumarone indene resin, a hydrogenated coumarone indene resin, a phenol-modified coumarone indene resin, and an epoxy-modified coumarone indene resin; an α-pinene resin and a β-pinene resin; a terpene-based resin such as a terpene resin, a terpene phenol resin, a hydrogenated terpene phenol resin, a hydrogenated terpene resin, an aromatic modified hydrogenated terpene resin, and an aromatic modified terpene resin; and a petroleum-based resin such as an aliphatic petroleum resin, an aromatic petroleum resin, and an aromatic-modified aliphatic petroleum resin. These may be used singly or in a combination of two or more types thereof.

As a more preferable viscosity imparting agent, a petroleum-based resin, a terpene-based resin, and a styrene-based resin, which do not include a polar group, may be employed, and the terpene-based resin is preferable. As the terpene-based resin, a terpene resin and a hydrogenated terpene resin are preferable, and the hydrogenated terpene resin is more preferable. In addition, as the terpene-based resin, more specifically, CLEARON P150, CLEARON P135, CLEARON P125, CLEARON P115, CLEARON P105, and CLEARON P85 (manufactured by Yasuhara Chemical Co., Ltd.) may be employed.

The content of the viscosity imparting agent in the composition is not particularly limited, and is preferably 10 to 60 mass %, and more preferably 15 to 50 mass % with respect to the total solid content of the composition in terms of more excellent effects of the present invention.

(Cross-linking Agent)

A cross-linking agent means a compound having a plurality of (two or more) cross-linking groups, and exhibits a function of imparting a cross-linking structure to the formed pressure sensitive adhesive sheet. However, the rubber having a cross-linking group is not included in the cross-linking agent.

The cross-linking agent may have a plurality of cross-linking groups, and is preferably 2 to 6 cross-linking groups, and more preferably 2 or 3 cross-linking groups in terms of more excellent effects of the present invention.

The type of the cross-linking agent is not particularly limited, and an isocyanate-based cross-linking agent, an epoxy-based cross-linking agent, a melamine-based cross-linking agent, a peroxide-based cross-linking agent, a urea-based cross-linking agent, a metal alkoxide-based cross-linking agent, a metal chelate-based cross-linking agent, a metal salt-based cross-linking agent, a carbodiimide-based cross-linking agent, an oxazoline-based cross-linking agent, an aziridine-based cross-linking agent, and an amine-based cross-linking agent may be employed. The isocyanate-based cross-linking agent (for example, a trimethylolpropane adduct of xylylene diisocyanate (manufactured by Mitsui Chemicals, Inc., trade name D110N) and the epoxy-based cross-linking agent are preferable.

In addition, a polyfunctional monomer (for example, dipentaerythritol hexa(meth)acrylate) having a plurality of polymerizable groups (particularly, a radical polymerizable group is preferable, and a (meth)acryloyl group or a vinyl group is more preferable) may be appropriately used as a cross-linking agent. In addition, the type of the radical polymerizable group is not particularly limited, and a (meth)acryloyl group, acrylamide group, a vinyl group, a styryl group, an allyl group, and the like may be employed. Among these, a methacryloyl group is preferable in terms of more excellent effects of the present invention.

The content of the cross-linking agent in the composition is not particularly limited, and is preferably 0.01 to 2 mass %, and more preferably 0.01 to 1 mass % with respect to the total solid content of the composition in terms of more excellent effects of the present invention.

(Solvent)

If necessary, the composition may include a solvent. Examples of the solvent used include water, an organic solvent (for example, esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; ketones such as methyl ethyl ketone and methyl isobutyl ketone; and alcohols such as methanol and butanol), and a mixed solvent thereof.

The composition may further include well-known additives. For example, polymerization initiators, colorants, powders such as pigments, dyes, surfactants, plasticizers, surface lubricants, leveling agents, softeners, antioxidants, anti-aging agents, light stabilizers, ultraviolet absorbers, polymerization inhibitor, inorganic or organic fillers, metal powders, particles, foil-like materials, and the like may be appropriately added according to uses.

A preparation method of the composition is not particularly limited, and a well-known method may be employed. For example, the composition may be prepared by mixing all the components together and thereafter stirring the mixture using well-known means.

<Characteristics of Composition>

The ratio between the number of moles of oxygen atoms in the composition and the number of moles of carbon atoms (the number of moles of oxygen atoms/the number of moles of carbon atoms) (hereinafter, also referred to as “O/C ratio”) is preferably 0.15 or lower, and is preferably 0.005 to 0.05. When the O/C ratio is in the above range, the relative permittivity of the pressure sensitive adhesive sheet further decreases, the temperature dependence of the relative permittivity further decreases, and thus the occurrence of malfunction of a capacitive touch panel including the pressure sensitive adhesive sheet is further prevented.

In a case where the composition includes a solvent, the O/C ratio indicates the O/C ratio in the entire component excluding the solvent.

The O/C ratio can be obtained by calculating the number of moles of oxygen atoms and the number of moles of carbon atoms in each component in the composition.

For example, in a case where the polymer in the composition is a polymer consisting of only repeating units including 10 carbon atoms and 2 oxygen atoms, the O/C ratio is calculated as 2/10=0.2.

In a case where a plurality of components (for example, the polymer, the rubber component, the viscosity imparting agent, and the like) are included in the composition, the O/C ratio can be obtained by using the number of moles of oxygen atoms and the number of moles of carbon atoms in each of the components.

For example, in a case where the composition includes the polymer, the rubber component, and the viscosity imparting agent, the O/C ratio can be obtained from the amounts of oxygen atoms and carbon atoms in each of the components and the amount of each of the components used. More specifically, the O/C ratio can be obtained by [the number of moles of oxygen atoms in the polymer+the number of moles of oxygen atoms in the rubber component+the number of moles of oxygen atoms in the viscosity imparting agent]/[the number of moles of carbon atoms in the polymer+the number of moles of carbon atoms in the rubber component+the number of moles of carbon atoms in the viscosity imparting agent].

<Production Method of Pressure Sensitive Adhesive Sheet>

A production method of the pressure sensitive adhesive sheet is not particularly limited, and for example, a pressure sensitive adhesive sheet can be formed by applying the composition onto a support, drying and removing volatile components such as solvents, if necessary, and further performing a curing treatment (for example, curing by heat, or curing by active energy rays such as ultraviolet rays), if necessary.

As an application method of the composition, various methods are used. Specifically, for example, methods such as roll coating, kiss roll coating, gravure coating, reverse coating, roll brushing, spray coating, dip roll coating, bar coating, knife coating, air knife coating, curtain coating, lip coating, and extrusion coating by a die coater or the like may be employed.

As a method of drying and removal, for example, a heating treatment may be employed, and the heating and drying temperature at this time is preferably 40° C. to 200° C., more preferably 50° C. to 180° C., and particularly preferably 70° C. to 170° C. By causing the heating temperature to be in the above range, a pressure sensitive adhesive sheet having excellent pressure sensitive adhesive properties can be obtained. As the drying time, an appropriate time may be employed. The heating time is preferably 5 seconds to 20 minutes, more preferably 5 seconds to 10 minutes, and particularly preferably 10 seconds to 5 minutes.

A method of the curing treatment is not particularly limited, and examples thereof include a heating treatment and an irradiation treatment with active energy rays such as ultraviolet rays.

Particularly, in a case where the product of partial polymerization or the monomer component is used as the component X, it is preferable that the pressure sensitive adhesive sheet is formed by applying the composition to the support and irradiating the resultant with radiation (for example, ultraviolet rays). When irradiation with radiation is performed, the composition in a state of being interposed between peelable sheets may be irradiated with radiation.

As the support, for example, the peelable sheet (a sheet subjected to a peeling treatment) may be used. As the peelable sheet, a silicone peelable liner is preferably used.

Examples of constituent materials for the sheet in the peelable sheet include plastic films such as polyethylene, polypropylene, polyethylene terephthalate, and polyester films, porous materials such as paper, fabric, and nonwoven fabric, appropriate thin materials such as nets, foamed sheets, metal foils, and laminates thereof. However, in terms of excellent surface smoothness, plastic films are appropriately used. By appropriately performing a peeling treatment such as a silicone treatment, a long-chain alkyl treatment, or a fluorine treatment on the surface of the sheet, the peelable sheet is obtained.

The thickness of the peelable sheet is preferably 5 to 200 μm, and more preferably 5 to 100 μm.

<Pressure Sensitive Adhesive Sheet>

By using the composition, a desired pressure sensitive adhesive sheet can be obtained.

The pressure sensitive adhesive sheet includes at least the polymer and the rubber component. The definitions and appropriate aspects of the polymer and the rubber component are as described above. In addition, as described above, in a case where the product of partial polymerization or the monomer component is used as the component X, the polymer can be obtained by polymerizing the component X through the curing treatment described above.

The content of the rubber component is 1 to 50 mass % with respect to the total mass of the pressure sensitive adhesive sheet. An appropriate range of the content of the rubber component with respect to the total mass of the pressure sensitive adhesive sheet is the same as the appropriate range of the content of the rubber component with respect to the total solid content of the above-described composition.

In addition, the pressure sensitive adhesive sheet may include various arbitrary components (for example, the viscosity imparting agent and the like) described above. An appropriate range of the content of each of the components is the same as the appropriate range of the content of each of the components with respect to the total solid content of the composition described above.

The thickness of the pressure sensitive adhesive sheet is not particularly limited, and is preferably 1 to 400 μm, more preferably 20 to 300 μm, and even more preferably 20 to 200 μm in terms of adhesiveness of each of members.

In addition, the thickness of the pressure sensitive adhesive sheet is a value obtained by measuring the thicknesses of the pressure sensitive adhesive sheet at at least 5 or more arbitrary points and arithmetically averaging the thicknesses.

The relative permittivity of the pressure sensitive adhesive sheet at a frequency of 100 kHz is not particularly limited, and is preferably 3.5 or lower, more preferably 3.3 or lower, even more preferably 3.2 or lower, and particularly preferably 2.5 or lower in terms of low permittivity.

A measurement method of the relative permittivity is as follows.

The pressure sensitive adhesive sheet (thickness 100 μm) is interposed between aluminum electrodes, and the relative permittivity thereof is measured at a frequency of 100 kHz by the following apparatus. Regarding the measurement, the average of measurement values of three samples is determined as the relative permittivity. In addition, the relative permittivity of the pressure sensitive adhesive sheet at a frequency of 100 kHz is measured on the basis of JIS K 6911.

The gel fraction of the pressure sensitive adhesive sheet is not particularly limited, and is preferably 20 to 98 mass %, more preferably 30 to 98 mass %, and even more preferably 30 to 75 mass %. In a case where the composition includes the cross-linking agent, the gel fraction may be controlled by adjusting the total amount of the cross-linking agent added and sufficiently considering effects of the cross-linking treatment temperature and the cross-linking treatment time. When the gel fraction is in the above range, an increase in the adhesion of the pressure sensitive adhesive sheet after being adhered to an adherend is extremely small, and a property of being easily re-peeled even after adhesion for a long period of time without residual adhesive is exhibited.

A measurement method of the gel fraction of the pressure sensitive adhesive sheet is as follows.

The gel fraction (the ratio of the solvent undissolved) may be obtained from undissolved matter in ethyl acetate. Specifically, the gel fraction is obtained from the mass fraction (unit: mass %) of undissolved matter after the pressure sensitive adhesive sheet is immersed in ethyl acetate at 40° C. for 20 hours with respect to a sample before the immersion. More specifically, the gel fraction is a value calculated by the following “measurement method of the gel fraction”.

(Measurement Method of Gel Fraction)

About 1 g of the pressure sensitive adhesive sheet is extracted, the mass thereof is measured, and the mass is referred to as “the mass of the pressure sensitive adhesive sheet before the immersion”. Next, after the extracted pressure sensitive adhesive sheet is immersed in 40 g of ethyl acetate at 40° C. for 20 hours, all the components undissolved in ethyl acetate (undissolved portion) are recovered, and the total undissolved portion that is recovered is dried at 80° C. for 4 hours to remove the ethyl acetate, and the mass thereof is measured as “the dried mass of the undissolved portion” (the mass of the pressure sensitive adhesive sheet after the immersion). In addition, the obtained numerical value is substituted into the following expression.

Gel fraction (mass %)=[(the dried mass of the undissolved portion)/(the mass of the pressure sensitive adhesive sheet before immersion)]×100

The temperature dependence of the relative permittivity of the pressure sensitive adhesive sheet obtained from a temperature dependence evaluation test, which will be described later, is preferably 20% or lower, more preferably 15% or lower, and particularly preferably 10% or lower. The lower limit thereof is not particularly limited, and the lower the temperature dependence, the more preferable. A temperature dependence of 0% is the most preferable.

A method of conducting the temperature dependence evaluation test will be described below in detail. In addition, the measurement of relative permittivity using an impedance measurement technique at each temperature described below is called a volumetric method. The volumetric method is conceptually a method of forming a capacitor by interposing a sample between electrodes and calculating permittivity from the measured capacitance. In addition, an environmental temperature to which an electronic device equipped with a capacitive touch panel is exposed is assumed to be 0° C. to 40° C., and a range of 0° C. to 40° C. is assumed to be a test environment in this evaluation test.

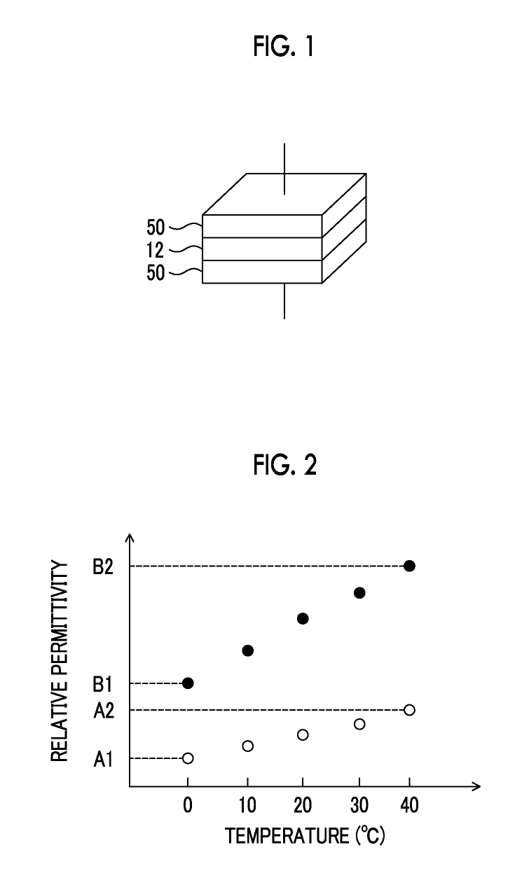

First, as illustrated in FIG. 1, a pressure sensitive adhesive sheet 12 (thickness: 100 to 500 μm) as a measurement object is interposed between a pair of aluminum electrodes 50 (electrode area: 28 mm×28 mm) and is subjected to a pressurizing and defoaming treatment at 40° C. and 5 atm for 20 minutes, thereby producing a sample for evaluation.

Thereafter, the temperature of the pressure sensitive adhesive sheet in the sample for evaluation is increased in stages from 0° C. to 40° C. by 10° C., the capacitance C is obtained through impedance measurement at 100 kHz using an impedance analyzer at each temperature. Thereafter, the obtained capacitance C is multiplied by the thickness T of the pressure sensitive adhesive sheet, and the resultant is thereafter divided by the product of the area S of the aluminum electrode and the vacuum permittivity ε₀ (8.854×10⁻¹² F/m), thereby calculating the relative permittivity. That is, the relative permittivity is calculated by using an expression (X): relative permittivity=(capacitance C×thickness T)/(area S×vacuum permittivity ε₀).

More specifically, the temperature of the pressure sensitive adhesive sheet is increased in stages to reach 0° C., 10° C., 20° C., 30° C., and 40° C., and after pressure sensitive adhesive sheet is left at each temperature for 5 minutes until the temperature thereof is stabilized, the capacitance C is obtained through impedance measurement at the corresponding, temperature at 100 kHz. From the obtained value, the relative permittivity at each temperature is calculated.

The thickness of the pressure sensitive adhesive sheet is a value obtained by measuring the thicknesses of the pressure sensitive adhesive sheet at at least 5 or more arbitrary points and arithmetically averaging the thicknesses.

Thereafter, among the calculated relative permittivity values, the minimum value and the maximum value are selected, and the ratio of the difference between the two to the minimum value is obtained. More specifically, a value (%) calculated from an expression [{(maximum value−minimum value)/minimum value}×100] is obtained, and the value is determined as the temperature dependence.

FIG. 2 shows an example of temperature dependence evaluation test results. The horizontal axis of FIG. 2 represents the temperature, and the vertical axis thereof represents the relative permittivity. In addition, FIG. 2 is an example of measurement results of two types of pressure sensitive adhesive sheet, in which one is indicated by white circles, and the other is indicated by black circles.

Referring to FIG. 2, in the pressure sensitive adhesive sheet A indicated by the white circles, the relative permittivities at temperatures are relatively close to each other, and the change therein is small. That is, it is shown that the relative permittivity of the pressure sensitive adhesive sheet A has a small change according to temperature, and the relative permittivity of the pressure sensitive adhesive sheet A even in cold regions and warm regions is less likely to change. Consequently, the capacitance between detection electrodes in a touch panel including the pressure sensitive adhesive sheet A is less likely to deviate from a value that is initially set, and malfunction of the touch panel is less likely to occur. In addition, the temperature dependence (%) of the pressure sensitive adhesive sheet A can be obtained by selecting A1 which is the minimum value of the white circles in FIG. 2 and A2 which is the maximum value and using an expression [(A2−A1)/A1×100].

On the other hand, in the pressure sensitive adhesive sheet B indicated by the black circles, the relative permittivity thereof significantly increases with an increase in temperature and has a large change. That is, it is shown that the relative permittivity of the pressure sensitive adhesive sheet B has a large change according to temperature, the capacitance between the detection electrodes is likely to deviate from the value that is initially set, resulting in each occurrence of malfunction of the touch panel. In addition, the temperature dependence (%) of the pressure sensitive adhesive sheet B can be obtained by selecting B1 which is the minimum value of the black circles in FIG. 2 and B2 which is the maximum value and using an expression [(B2−B1)/B1×100].

That is, the temperature dependence represents the degree of a change in permittivity according to temperature. When this value is low, a change in the relative permittivity from a low temperature (0° C.) to a high temperature (40° C.) is small, and malfunction is less likely to occur. On the other hand, when this value is high, a change in the relative permittivity from a low temperature (0° C.) to a high temperature (40° C.) is large, and malfunction of the touch panel easily occurs.

Although the temperature dependence test in an aspect of a test environment at 0° C. to 40° C. has been described above in detail, the temperature may be changed (for example, changed to −40° C. to 80° C.), and the temperature dependence may be measured in the temperature range. From the viewpoint of a wide operation environment temperature to be coped with, it is preferable that a change in a temperature range between −40° C. to 80° C. is small.

The range of the ratio between the number of moles of oxygen atoms in the pressure sensitive adhesive sheet and the number of moles of carbon atoms (the number of moles of oxygen atoms/the number of moles of carbon atoms) (“O/C ratio”) is not particularly limited, and is preferably in the appropriate range of the O/C ratio of the composition described above.

A peelable sheet (peelable film) may be disposed on at least one surface of the pressure sensitive adhesive sheet, and the resultant may be treated as a pressure sensitive adhesive film. In terms of treating properties, a pressure sensitive adhesive film in which peelable sheets are disposed on both surfaces of the pressure sensitive adhesive sheet is preferable.

The pressure sensitive adhesive sheet of the present invention can be applied in various applications, for example, in a touch panel application, and can be suitably used to produce a touch panel (particularly, a capacitive touch panel) among the applications.

Hereinafter, an aspect in which the pressure sensitive adhesive sheet is applied in the touch panel application will be described in detail.

<Laminate for Touch Panel and Capacitive Touch Panel>

A laminate for a touch panel of the present invention includes the pressure sensitive adhesive sheet of the present invention described above and a capacitive touch panel sensor.

An aspect of the laminate for a touch panel of the present invention will be described with reference to the drawings.

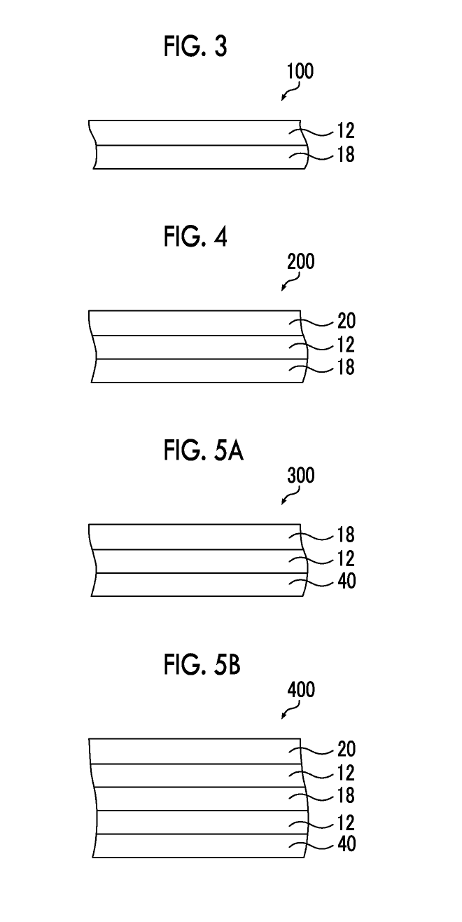

FIG. 3 is a cross-sectional view schematically illustrating an aspect of the laminate for a touch panel of the present invention. In FIG. 3, a laminate 100 for a touch panel includes a pressure sensitive adhesive sheet 12 and a capacitive touch panel sensor 18.

In addition, FIG. 4 is a cross-sectional view schematically illustrating another aspect of the laminate for a touch panel of the present invention. In FIG. 4, a laminate 200 for a touch panel includes a protective substrate 20, the pressure sensitive adhesive sheet 12, and the capacitive touch panel sensor 18.

In addition, a capacitive touch panel of the present invention is provided with the capacitive touch panel sensor, the pressure sensitive adhesive sheet of the present invention described above, and a display device in this order. An aspect of the capacitive touch panel of the present invention will be described with reference to the drawings.

FIG. 5A is a cross-sectional view schematically illustrating an aspect of the capacitive touch panel of the present invention. In FIG. 5A, a capacitive touch panel 300 includes the capacitive touch panel sensor 18, the pressure sensitive adhesive sheet 12, and a display device 40.

In addition, FIG. 5B is a cross-sectional view schematically illustrating another aspect of the capacitive touch panel of the present invention. In FIG. 5B, a capacitive touch panel 400 includes the protective substrate 20, the pressure sensitive adhesive sheet 12, the capacitive touch panel sensor 18, the pressure sensitive adhesive sheet 12, and the display device 40.

The capacitive touch panel sensor 18 is a sensor which is disposed on a display device (on an operator side) and detects the position of an external conductor such as a finger of a human using a change in capacitance that occurs when the external conductor such as a finger of a human comes into contact with (approaches) the sensor.

Although the configuration of the capacitive touch panel sensor 18 is not particularly limited, the capacitive touch panel sensor 18 typically has detection electrodes (particularly detection electrodes extending in an X direction and detection electrodes extending in a Y direction) and specifies the coordinates of the finger by detecting a change in capacitance of the detection electrode that the finger comes into contact with or approaches.

The protective substrate 20 is a substrate disposed on the pressure sensitive adhesive sheet and exhibits a role of protecting the capacitive touch panel sensor 18, which will be described later, from an external environment, and the primary surface thereof forms a touch surface. The protective substrate 20 is preferably a transparent substrate, and a plastic film, a plastic plate, a glass plate, and the like are used. It is preferable that the thickness of the substrate is appropriately selected according to corresponding applications.

The display device 40 is a device having a display surface that displays an image, and each member is disposed on a display screen side. The type of the display device 40 is not particularly limited, and a well-known display device may be used. Examples thereof include a cathode ray tube (CRT) display device, a liquid crystal display device (LCD), an organic light-emitting diode (OLED) display device, a vacuum fluorescent display (VFD), a plasma display panel (PDP), a surface-conduction electron-emitter display (SED), a field emission display (FED), and an electronic paper (E-Paper).

### EXAMPLES

Hereinafter, the present invention will be described in further detail with reference to examples, but the present invention is not limited thereto.

### Example 1

27 parts by mass of N-vinyl-2-pyrrolidone (NVP), 66 parts by mass of 2-ethylhexyl acrylate (2EHA), 0.1 parts by mass of 2,2′-azobisisobutyronitrile as a polymerization initiator, and 80 parts by mass of ethyl acetate were put in a four-neck flask equipped with a stirring blade, a thermometer, a nitrogen gas introduction tube, and a cooler. While the mixture was gently stirred, nitrogen gas was introduced thereinto for nitrogen substitution for 1 hour. Thereafter, the temperature of the liquid in the flask was retained at approximately 75° C. for a polymerization reaction for 2 hours, thereby preparing a polymer solution including a polymer with a weight-average molecular weight of 600,000.

Next, 0.5 parts by mass of a trimethylolpropane adduct of xylylene diisocyanate (manufactured by Mitsui Chemicals, Inc., trade name D110N) as a cross-linking agent and 7 parts by mass of isobutylene rubber were mixed in the polymer solution obtained as described above, thereby preparing a pressure sensitive adhesive composition.

Next, the obtained pressure sensitive adhesive composition was applied to one surface of a polyethylene terephthalate (PET) film (manufactured by Mitsubishi Polyester Film Corporation, MRF38) of 38 μm subjected to a silicone treatment to cause the thickness of a pressure sensitive adhesive sheet after drying to become 100 μm. The resultant was dried at 130° C. for 3 minutes, thereby producing a pressure sensitive adhesive film provided with a pressure sensitive adhesive sheet interposed between two peelable sheets.

### Example 2

66 parts by mass of 2-ethylhexyl acrylate (2EHA), 27 parts by mass of N-vinyl-2-pyrrolidone (NVP), and 0.1 parts by mass of a photopolymerization initiator (trade name: IRGACURE184, manufactured by BASF SE) were input to a four-neck flask, thereby preparing a monomer mixture. Next, the monomer mixture was exposed to ultraviolet rays in a nitrogen atmosphere for partial photopolymerization, thereby obtaining a product of partial polymerization (acrylic polymer syrup) with a polymerization rate of about 10 mass %.

After 7 parts by mass of isobutylene rubber and 0.05 parts by mass of dipentaerythritol pentaacrylate (trade name “KAYARAD DPHA”, manufactured by Nippon Kayaku Co., Ltd.) were added to the total amount of the obtained acrylic polymer syrup, this mixture was homogenously mixed, thereby preparing a pressure sensitive adhesive composition.

Next, the pressure sensitive adhesive composition prepared as above was applied to the peeling treatment surface of a polyester film (trade name: DIAFOIL MRF, manufactured by Mitsubishi Plastics, Inc.) which was subjected to a silicone peeling treatment on one surface and had a thickness of 38 μm so as to cause the thickness of a pressure sensitive adhesive sheet to become 100 μm, thereby forming an application layer. Next, the surface of the application layer was covered with a polyester film (trade name: DIAFOIL MRE, manufactured by Mitsubishi Plastics, Inc.) which was subjected to a silicone peeling treatment on one surface and had a thickness of 38 μm so as to cause the peeling treatment surface of the film to be on the application layer side. Accordingly, the application layer was shielded from oxygen. The film having the application layer obtained as described above was irradiated with ultraviolet rays from a chemical light lamp (manufactured by Toshiba Corporation) at an irradiance of 5 mW/cm² (measured with TOPCON UVR-T1 having a maximum sensitivity at about 350 nm) for 360 seconds such that the application layer was cured, thereby producing a pressure sensitive adhesive film provided with a pressure sensitive adhesive sheet interposed between two peelable sheets. The polyester films covering both surfaces of the pressure sensitive adhesive sheet function as peelable liners.

### Examples 3 to 14 and Comparative Examples 1, 3, 5, 7, 10, 12, and 14

Pressure sensitive adhesive films were produced using the same process as that of Example 1 except that the types of components used and the amounts thereof mixed are changed as shown in Table 1.

### Examples 15 to 26 and Comparative Examples 2, 4, 6, 8, 11, 13, and 15

Pressure sensitive adhesive films were produced using the same process as that of Example 2 except that the types of components used and the amounts thereof mixed are changed as shown in Table 1.

### Example 27

18 parts by mass of 2-ethylhexyl acrylate (2EHA), 5 parts by mass of N-vinyl-2-pyrrolidone (NVP), 4 parts by mass of a photopolymerization initiator (trade name: IRGACURE184, manufactured by BASF SE), Polyvest110 (10 parts by mass), and UC203 (15 parts by mass) were homogeneously heated and mixed, thereby preparing a pressure sensitive adhesive composition.

Next, the pressure sensitive adhesive composition prepared as above was applied to the peeling treatment surface of a polyester film (trade name: DIAFOIL MRF, manufactured by Mitsubishi Plastics, Inc.) which was subjected to a silicone peeling treatment on one surface and had a thickness of 38 μm so as to cause the final thickness to become 100 μm, thereby forming an application layer. Next, the surface of the application layer applied was covered with a polyester film (trade name: DIAFOIL MRE, manufactured by Mitsubishi Plastics, Inc.) which was subjected to a silicone peeling treatment on one surface and had a thickness of 38 μm so as to cause the peeling treatment surface of the film to be on the application layer side. Accordingly, the application layer was shielded from oxygen. The sheet having the application layer obtained as described above was irradiated with ultraviolet rays from a chemical light lamp (manufactured by Toshiba Corporation) at an irradiance of 5 mW/cm² (measured with TOPCON UVR-T1 having a maximum sensitivity at about 350 nm) for 450 seconds such that the application layer was cured, thereby producing a pressure sensitive adhesive film provided with a pressure sensitive adhesive sheet interposed between two peelable sheets. The polyester films covering both surfaces of the pressure sensitive adhesive sheet function as peelable liners.

### Comparative Example 9 and Examples 28 to 30

Pressure sensitive adhesive films were produced using the same process as that of Example 27 except that the types of monomers used and the amounts thereof mixed are changed as shown in Table 1.

The pressure sensitive adhesive films obtained in the examples and the comparative examples were subjected to the following measurements.

(Measurement of Relative Permittivity) Regarding the measurement of relative permittivity, the relative permittivity of the pressure sensitive adhesive sheet at a frequency of 100 kHz was measured on the basis of JIS K 6911.

(Gel Fraction)

Regarding the measurement of e fraction, measurement was performed using ethyl acetate as described above.

(Temperature Dependence of Relative Permittivity)

(Production of Sample for Temperature Dependence Evaluation Test)

The pressure sensitive adhesive sheet exposed by peeling one polyester film of the pressure sensitive adhesive film produced in each of the examples and the comparative examples was bonded onto an Al substrate having a size of 28 mm in length×28 mm in width and a thickness of 0.5 mm, and the pressure sensitive adhesive sheet exposed by peeling the other polyester film was thereafter bonded to the Al substrate. Thereafter, the resultant was subjected to a pressurizing and defoaming treatment at 40° C. and 5 atm for 20 minutes, thereby producing a sample for evaluation.

(Method of Temperature Dependence Evaluation Test)

Using the sample for a temperature dependence evaluation test produced as above, impedance measurement was performed by an impedance analyzer (4294A, manufactured by Agilent Technologies Japan, Ltd.) at 100 kHz, and the relative permittivity of the pressure sensitive adhesive sheet was measured.

Specifically, the sample for a temperature dependence evaluation test was increased in temperature in stages from 0° C. to 40° C. by 10° C., and the capacitance C is obtained through impedance measurement at 100 kHz using the impedance analyzer (4294A, manufactured by Agilent Technologies Japan, Ltd.) at each temperature. At each temperature, the sample was left for 5 minutes until the temperature thereof became stable.

Thereafter, using the obtained capacitance C, the relative permittivity was calculated at each temperature by using the expression (X).

relative permittivity=(capacitance C×thickness T)/(area S×vacuum permittivity ε₀) Expression (X)

The thickness T represents the thickness of the pressure sensitive adhesive sheet, the area S means the area of the aluminum electrode (20 mm in length×20 mm in width), and the vacuum permittivity co means a physical constant (8.854×10⁻¹² F/m).

Among the calculated relative permittivity values, the minimum value and the maximum value were selected, and the temperature dependence (%) was obtained by using the expression [(maximum value−minimum value)/minimum value×100].

Temperature adjustment was performed using a liquid nitrogen cooling stage in a case of a low temperature and using a hot plate in a case of a high temperature.

(Adhesion)

The pressure sensitive adhesive film produced in each of the examples and the comparative examples was cut into 2.5 cm×5.0 cm, one peelable sheet was peeled, and the exposed pressure sensitive adhesive sheet was bonded to a glass substrate. Next, the other peelable sheet was peeled, and the exposed pressure sensitive adhesive sheet was bonded to an end of a polyimide film (Kapton 100H (thickness 25 μm, manufactured by Du Pont-Toray Co., Ltd.)) that was cut into 15 cm×3 cm in advance. The produced sample for evaluation was subjected to a pressurizing and defoaming treatment at 40° C. and 5 atm for 60 minutes to be used as an evaluation sample.

Next, using Autograph AGS-X manufactured by Shimadzu Corporation, one end of the Kapton film that was not in contact with the pressure sensitive adhesive sheet was set in a shape to be pulled (peeled) in a 180-degree direction and was subjected to a 180-degree peel tensile test (speed: 30 mm/s), and adhesion was obtained.

Symbols in Table 1 indicate the following.

2EHA: 2-ethylhexyl acrylate

ISTA: isostearyl acrylate

IBXA: isobornyl acrylate

NVP: N-vinyl-2-pyrrolidone

NVC: N-vinylcaprolactam

M-140: N-acryloyloxyethyl hexahydrophthalimide

NDA: 1,9-bis(acryloyloxy)nonane

DPPA: dipentaerythritol pentaacrylate

D110N: a trimethylolpropane adduct of xylylene diisocyanate (manufactured by Mitsui Chemicals, Inc.)

Polyisobutylene: polyisobutylene

Polyvest110: polybutadiene (manufactured by Evonik Degussa GmbH)

LBR305: polybutadiene (manufactured by Kuraray Co., Ltd.)

LIR30: polyisoprene (manufactured by Kuraray Co., Ltd.)

UC102: an ester compound of a maleic anhydride adduct of a polyisoprene polymer and 2-hydroxyethyl methacrylate (manufactured by Kuraray Co., Ltd.)

UC203: an ester compound of a maleic anhydride adduct of a polyisoprene polymer and 2-hydroxyethyl methacrylate (manufactured by Kuraray Co., Ltd.)

CLEARON P85, P135: terpene resin (manufactured by Yasuhara Chemical Co., Ltd.)

AIBN: 2,2′-azobisisobutyronitrile

TPO: Lucirine TPO (BASF SE)

IRG184: IRGACURE184 (manufactured by BASF SE)

In addition, in Table 1, the monomer X represents a monomer having a nitrogen atom-containing cyclic structure, the monomer Y represents a (meth)acrylic monomer having an alkyl group with 3 to 22 carbon atoms at an ester end.

In addition, the numerical values in the rows of each of the components (the monomer, the cross-linking agent, the rubber, the viscosity imparting agent, and the polymerization initiator) in Table 1 represent parts by mass.

TABLE 1

| | | | Compar- | Compar- | Compar- | Compar- | Compar- | Compar- | Compar- | Compar- |
|---|---|---|---|---|---|---|---|---|---|---|
| | | | ative | ative | ative | ative | ative | ative | ative | ative |
| | | | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 |
| Monomer | Monomer Y | 2EHA | 66 | 66 | 33 | 66 | 66 | 66 | 7 | 7 |
| | | ISTA | 0 | 0 | 0 | 0 | 0 | 0 | 0 | 0 |
| | | IBXA | 0 | 0 | 27 | 27 | 0 | 0 | 0 | 0 |
| | Monomer X | NVP | 27 | 27 | 0 | 0 | 1.5 | 1.5 | 27 | 27 |
| | | NVC | 0 | 0 | 0 | 0 | 0 | 0 | 0 | 0 |
| | Other | M-140 | 0 | 0 | 0 | 0 | 0 | 0 | 0 | 0 |

| Cross-linking | NDA | 0 | 0 | 0 | 0 | 0 | 0 | 0 | 0 |
|---|---|---|---|---|---|---|---|---|---|
| agent | DPPA | 0 | 0.05 | 0 | 0.05 | 0 | 0.05 | 0 | 0.05 |
| | D110N | 0.5 | 0 | 0.5 | 0 | 0.5 | 0 | 0.5 | 0 |
| Rubber | Polyisobutylene | 0 | 0 | 7 | 7 | 7 | 7 | 7 | 7 |
| | Polyvest110 | 0 | 0 | 0 | 0 | 0 | 0 | 0 | 0 |
| | LBR305 | 0 | 0 | 0 | 0 | 0 | 0 | 0 | 0 |
| | LIR30 | 0 | 0 | 0 | 0 | 0 | 0 | 0 | 0 |
| | UC102 (including | 0 | 0 | 0 | 0 | 0 | 0 | 0 | 0 |
| | cross-linking group) | | | | | | | | |
| | UC203 (including | 0 | 0 | 0 | 0 | 0 | 0 | 0 | 0 |
| | cross-linking group) | | | | | | | | |
| Viscosity | CLEARON P85 | 0 | 0 | 0 | 0 | 0 | 0 | 0 | 0 |
| imparting agent | CLEARON P135 | 0 | 0 | 0 | 0 | 0 | 0 | 0 | 0 |
| Polymerization | AIBN | 0.1 | 0 | 0.1 | 0 | 0.1 | 0 | 0.1 | 0 |
| initiator | TPO | 0 | 0 | 0 | 0 | 0 | 0 | 0 | 0 |
| | Irg184 | 0 | 0.1 | 0 | 0.1 | 0 | 0.1 | 0 | 0.1 |
| Ratio of mass of monomer X to total | | 29.0 | 29.0 | 0.0 | 0.0 | 2.2 | 2.2 | 79.4 | 79.4 |
| monomer component (mass %) | | | | | | | | | |
| Ratio of mass of monomer Y to total | | 71.0 | 71.0 | 100.0 | 100.0 | 97.8 | 97.8 | 20.6 | 20.6 |
| monomer component (mass %) | | | | | | | | | |
| Amount of rubber component to total | | 0.0 | 0.0 | 10.4 | 7.0 | 9.3 | 9.4 | 16.8 | 17.0 |
| solid content of composition | | | | | | | | | |
| (mass %) | | | | | | | | | |
| Evaluation | Relative permittivity | 4.1 | 4.1 | 3.2 | 3.2 | 2.8 | 2.8 | 2.8 | 2.8 |
| | Relative permittivity | 30% | 30% | 14% | 14% | 6% | 6% | 6% | 6% |
| | temperature | | | | | | | | |
| | dependence (0° C. to | | | | | | | | |
| | 40° C.) | | | | | | | | |
| | Relative permittivity | — | — | — | — | — | — | — | — |
| | temperature | | | | | | | | |
| | dependence (−40° C. | | | | | | | | |
| | to 80° C.) | | | | | | | | |
| | Adhesion (N/mm) | 0.3 | 0.4 | 0.2 | 0.3 | 0.1 | 0.1 | 0.2 | 0.2 |
| | Gel fraction | 90% | 91% | 43% | 43% | 39% | 39% | 39% | 39% |
| | (mass %) | | | | | | | | |

| | | | Compar- | Compar- | Compar- | Compar- | Compar- | Compar- | Compar- |
|---|---|---|---|---|---|---|---|---|---|
| | | | ative | ative | ative | ative | ative | ative | ative |
| | | | Exam- | Exam- | Exam- | Exam- | Exam- | Exam- | Exam- |
| | | | ple 9 | ple 10 | ple 11 | ple 12 | ple 13 | ple 14 | ple 15 |
| Monomer | Monomer Y | 2EHA | 0 | 66 | 66 | 18 | 18 | 66 | 66 |
| | | ISTA | 0 | 0 | 0 | 66 | 66 | 0 | 0 |
| | | IBXA | 30 | 0 | 0 | 0 | 0 | 0 | 0 |
| | Monomer X | NVP | 0 | 27 | 27 | 9 | 9 | 27 | 27 |
| | | NVC | 0 | 0 | 0 | 0 | 0 | 0 | 0 |
| | Other | M-140 | 0 | 0 | 0 | 0 | 0 | 0 | 0 |

| Cross-linking | NDA | 0 | 0 | 0 | 0 | 0 | 0 | 0 |
|---|---|---|---|---|---|---|---|---|
| agent | DPPA | 0 | 0 | 0.05 | 0 | 0.05 | 0 | 0.05 |
| | D110N | 0 | 0.5 | 0 | 0.5 | 0 | 0.5 | 0 |
| Rubber | Polyisobutylene | 0 | 0.5 | 0.5 | 7 | 7 | 120 | 120 |
| | Polyvest110 | 140 | 0 | 0 | 0 | 0 | 0 | 0 |
| | LBR305 | 0 | 0 | 0 | 0 | 0 | 0 | 0 |
| | LIR30 | 0 | 0 | 0 | 0 | 0 | 0 | 0 |
| | UC102 (including | 0 | 0 | 0 | 0 | 0 | 0 | 0 |
| | cross-linking group) | | | | | | | |
| | UC203 (including | 70 | 0 | 0 | 0 | 0 | 0 | 0 |
| | cross-linking group) | | | | | | | |
| Viscosity | CLEARON P85 | 0 | 0 | 0 | 0 | 0 | 0 | 0 |
| imparting agent | CLEARON P135 | 0 | 0 | 0 | 0 | 0 | 0 | 0 |
| Polymerization | AIBN | 0 | 0.1 | 0 | 0.1 | 0.1 | 0.1 | 0.1 |
| initiator | TPO | 0 | 0 | 0 | 0 | 0 | 0 | 0 |
| | Irg184 | 4 | 0 | 0.1 | 0 | 0 | 0 | 0 |
| Ratio of mass of monomer X to total | | 0.0 | 29.0 | 29.0 | 9.7 | 9.7 | 29.0 | 29.0 |
| monomer component (mass %) | | | | | | | | |
| Ratio of mass of monomer Y to total | | 100.0 | 71.0 | 71.0 | 90.3 | 90.3 | 71.0 | 71.0 |
| monomer component (mass %) | | | | | | | | |
| Amount of rubber component to total | | 86.1 | 0.5 | 0.5 | 7.0 | 7.0 | 56.2 | 56.3 |
| solid content of composition | | | | | | | | |
| (mass %) | | | | | | | | |
| Evaluation | Relative permittivity | 2.9 | 4.1 | 4.1 | 3.1 | 3.1 | 2.8 | 2.9 |
| | Relative permittivity | 5% | 28% | 26% | 11% | 10% | 8% | 8% |
| | temperature | | | | | | | |
| | dependence (0° C. to | | | | | | | |
| | 40° C.) | | | | | | | |
| | Relative permittivity | — | — | — | — | — | — | — |
| | temperature | | | | | | | |
| | dependence (−40° C. | | | | | | | |
| | to 80° C.) | | | | | | | |
| | Adhesion (N/mm) | 0.2 | 0.4 | 0.5 | 0.5 | 0.5 | 0.2 | 0.3 |
| | Gel fraction | 40% | 82% | 83% | 52% | 52% | 28% | 27% |
| | (mass %) | | | | | | | |

TABLE 2

| | | | Example | Example | Example | Example | Example | Example | Example | Example | Example | Example | Example | Example | Example |
|---|---|---|---|---|---|---|---|---|---|---|---|---|---|---|---|
| | | | 1 | 3 | 4 | 5 | 6 | 7 | 8 | 9 | 10 | 11 | 12 | 13 | 14 |
| Monomer | Monomer Y | 2EHA | 66 | 66 | 33 | 66 | 66 | 66 | 66 | 66 | 66 | 0 | 9 | 66 | 10 |
| | | ISTA | 0 | 0 | 0 | 0 | 0 | 0 | 0 | 0 | 0 | 66 | 66 | 0 | 0 |
| | | IBXA | 0 | 0 | 0 | 0 | 0 | 0 | 0 | 0 | 0 | 0 | 0 | 0 | 0 |
| | Monomer X | NVP | 27 | 0 | 27 | 27 | 27 | 27 | 27 | 27 | 27 | 27 | 19 | 7 | 27 |
| | | HVC | 0 | 27 | 0 | 0 | 0 | 0 | 0 | 0 | 0 | 0 | 0 | 0 | 0 |
| | Other | M-140 | 0 | 0 | 21 | 0 | 0 | 0 | 0 | 0 | 0 | 0 | 0 | 20 | 0 |

| Cross-linking | NDA | 0 | 0 | 0 | 0 | 0 | 0 | 0 | 0 | 0 | 0 | 0 | 0 | 0 |
|---|---|---|---|---|---|---|---|---|---|---|---|---|---|---|
| agent | DPPA | 0 | 0 | 0 | 0 | 0 | 0 | 0 | 0 | 0 | 0 | 0 | 0 | 0 |
| | D110N | 0.5 | 0.5 | 0.5 | 0.5 | 0.5 | 0.5 | 0.5 | 0.5 | 0.5 | 0.5 | 0.5 | 0.5 | 0.5 |
| Rubber | Polyisobulylene | 7 | 7 | 7 | 4 | 4 | 7 | 30 | 60 | 7 | 7 | 7 | 7 | 7 |
| | Polyvest110 | 0 | 0 | 0 | 0 | 0 | 0 | 0 | 0 | 0 | 0 | 0 | 0 | 0 |
| | LBR305 | 0 | 0 | 0 | 3 | 0 | 0 | 0 | 0 | 0 | 0 | 0 | 0 | 0 |
| | LIR30 | 0 | 0 | 0 | 0 | 3 | 0 | 0 | 0 | 0 | 0 | 0 | 0 | 0 |
| | UC102 (including | 0 | 0 | 0 | 0 | 0 | 3 | 0 | 0 | 0 | 0 | 0 | 0 | 0 |
| | cross-linking group) | | | | | | | | | | | | | |
| | UC203 (including | 0 | 0 | 0 | 0 | 0 | 0 | 0 | 0 | 0 | 0 | 0 | 0 | 0 |
| | cross-linking group) | | | | | | | | | | | | | |
| Viscosity | CLEARON P85 | 0 | 0 | 0 | 0 | 0 | 0 | 0 | 0 | 23 | 0 | 0 | 0 | 0 |
| imparting agent | CLEARON P135 | 0 | 0 | 0 | 0 | 0 | 0 | 0 | 0 | 0 | 0 | 0 | 0 | 0 |
| Polymerization | AIBN | 0.1 | 0.1 | 0.1 | 0.1 | 0.1 | 0.1 | 0.1 | 0.1 | 0.1 | 0.1 | 0.1 | 0.1 | 0.1 |
| initiator | TPO | 0 | 0 | 0 | 0 | 0 | 0 | 0 | 0 | 0 | 0 | 0 | 0 | 0 |
| | Irg184 | 0 | 0 | 0 | 0 | 0 | 0 | 0 | 0 | 0 | 0 | 0 | 0 | 0 |
| Ratio of mass of monomer X to total | | 29.0 | 29.0 | 33.3 | 29.0 | 29.0 | 29.0 | 29.0 | 29.0 | 29.0 | 29.0 | 20.2 | 7.5 | 73.0 |
| monomer component (mass %) | | | | | | | | | | | | | | |
| Ratio of mass of monomer Y to total | | 71.0 | 71.0 | 40.7 | 71.0 | 71.0 | 71.0 | 71.0 | 71.0 | 71.0 | 71.0 | 79.8 | 71.0 | 27.0 |
| monomer component (mass %) | | | | | | | | | | | | | | |
| Amount of rubber component to total | | 7.0 | 7.0 | 7.9 | 7.0 | 7.0 | 9.7 | 24.3 | 39.1 | 5.7 | 7.0 | 6.9 | 7.0 | 15.7 |
| solid content of composition | | | | | | | | | | | | | | |
| (mass %) | | | | | | | | | | | | | | |
| Evaluation | Relative permittivity | 3.2 | 3.2 | 3.2 | 3.2 | 3.2 | 3.2 | 2.9 | 2.9 | 2.9 | 3.2 | 3 | 3.2 | 2.8 |
| | Relative permittivity | 14% | 13% | 13% | 12% | 11% | 10% | 9% | 8% | 9% | 14% | 10% | 12% | 9% |
| | temperature | | | | | | | | | | | | | |
| | dependence (0° C. to | | | | | | | | | | | | | |
| | 40° C.) | | | | | | | | | | | | | |
| | Relative permittivity | 38% | 37% | 37% | 36% | 34% | 32% | 28% | 27% | 28% | 38% | 32% | 36% | 27% |
| | temperature | | | | | | | | | | | | | |
| | dependence (−40° C. | | | | | | | | | | | | | |
| | to 80° C.) | | | | | | | | | | | | | |
| | Adhesion (N/mm) | 1 | 1 | 1.3 | 1.3 | 1.4 | 1.3 | 1.1 | 1 | 1.4 | 1.4 | 1.1 | 1 | 0.6 |
| | Gel fraction | 50% | 52% | 53% | 62% | 63% | 72% | 43% | 38% | 46% | 52% | 52% | 53% | 46% |
| | (mass %) | | | | | | | | | | | | | |

TABLE 3

| | | | Example | Example | Example | Example | Example | Example | Example | Example | Example | Example | Example | Example | Example |
|---|---|---|---|---|---|---|---|---|---|---|---|---|---|---|---|
| | | | 2 | 15 | 16 | 17 | 18 | 19 | 20 | 21 | 22 | 23 | 24 | 25 | 26 |
| Monomer | Monomer Y | 2EHA | 66 | 66 | 33 | 66 | 66 | 66 | 66 | 66 | 66 | 0 | 9 | 66 | 10 |
| | | ISTA | 0 | 0 | 0 | 0 | 0 | 0 | 0 | 0 | 0 | 66 | 66 | 0 | 0 |
| | | IBXA | 0 | 0 | 0 | 0 | 0 | 0 | 0 | 0 | 0 | 0 | 0 | 0 | 0 |
| | Monomer X | NVP | 27 | 0 | 27 | 27 | 27 | 27 | 27 | 27 | 27 | 27 | 19 | 7 | 27 |
| | | HVC | 0 | 27 | 0 | 0 | 0 | 0 | 0 | 0 | 0 | 0 | 0 | 0 | 0 |
| | Other | M-140 | 0 | 0 | 21 | 0 | 0 | 0 | 0 | 0 | 0 | 0 | 0 | 20 | 0 |

| Cross-linking | NDA | 0 | 0.05 | 0 | 0 | 0 | 0 | 0 | 0 | 0 | 0 | 0 | 0 | 0 |
|---|---|---|---|---|---|---|---|---|---|---|---|---|---|---|
| agent | DPPA | 0.05 | 0 | 0.05 | 0.05 | 0.05 | 0.05 | 0.05 | 0.05 | 0.05 | 0.05 | 0.05 | 0.05 | 0 |
| | D110N | 0 | 0 | 0 | 0 | 0 | 0 | 0 | 0 | 0 | 0 | 0 | 0 | 0.5 |
| Rubber | Polyisobutylene | 7 | 7 | 7 | 4 | 4 | 7 | 30 | 60 | 7 | 7 | 7 | 7 | 7 |
| | Polyvest110 | 0 | 0 | 0 | 0 | 0 | 0 | 0 | 0 | 0 | 0 | 0 | 0 | 0 |
| | LBR305 | 0 | 0 | 0 | 3 | 0 | 0 | 0 | 0 | 0 | 0 | 0 | 0 | 0 |
| | LIR30 | 0 | 0 | 0 | 0 | 3 | 0 | 0 | 0 | 0 | 0 | 0 | 0 | 0 |
| | UC102 (including | 0 | 0 | 0 | 0 | 0 | 3 | 0 | 0 | 0 | 0 | 0 | 0 | 0 |
| | cross-linking group) | | | | | | | | | | | | | |
| | UC203 (including | 0 | 0 | 0 | 0 | 0 | 0 | 0 | 0 | 0 | 0 | 0 | 0 | 0 |
| | cross-linking group) | | | | | | | | | | | | | |
| Viscosity | CLEARON P85 | 0 | 0 | 0 | 0 | 0 | 0 | 0 | 0 | 23 | 0 | 0 | 0 | 0 |
| imparting agent | CLEARON P135 | 0 | 0 | 0 | 0 | 0 | 0 | 0 | 0 | 0 | 0 | 0 | 0 | 0 |
| Polymerization | AIBN | 0 | 0 | 0 | 0 | 0 | 0 | 0 | 0.1 | 0.1 | 0 | 0.1 | 0 | 0.1 |
| initiator | TPO | 0 | 0 | 0 | 0 | 0 | 0 | 0 | 0 | 0 | 0 | 0 | 0 | 0 |
| | Irg184 | 0.1 | 0.1 | 0.1 | 0.1 | 0.1 | 0.1 | 0.1 | 0 | 0 | 0.1 | 0 | 0.1 | 0 |
| Ratio of mass of monomer X to total | | 29.0 | 29.0 | 33.3 | 29.0 | 29.0 | 29.0 | 29.0 | 29.0 | 29.0 | 29.0 | 20.2 | 7.5 | 73.0 |
| monomer component (mass %) | | | | | | | | | | | | | | |
| Ratio of mass of monomer Y to total | | 71.0 | 71.0 | 40.7 | 71.0 | 71.0 | 71.0 | 71.0 | 71.0 | 71.0 | 71.0 | 79.8 | 71.0 | 27.0 |
| monomer component (mass %) | | | | | | | | | | | | | | |
| Amount of rubber component to total | | 7.0 | 7.0 | 7.9 | 7.0 | 7.0 | 9.7 | 24.4 | 39.2 | 5.7 | 7.0 | 6.9 | 7.0 | 15.7 |
| solid content of composition | | | | | | | | | | | | | | |
| (mass %) | | | | | | | | | | | | | | |
| Evaluation | Relative permittivity | 3.2 | 3.2 | 3.2 | 3.2 | 3.2 | 3.2 | 2.9 | 2.8 | 2.9 | 3.2 | 3 | 3.1 | 2.9 |
| | Relative permittivity | 14% | 13% | 13% | 12% | 11% | 10% | 9% | 8% | 9% | 14% | 10% | 12% | 9% |
| | temperature | | | | | | | | | | | | | |
| | dependence (0° C. to | | | | | | | | | | | | | |
| | 40° C.) | | | | | | | | | | | | | |
| | Relative permittivity | 38% | 37% | 37% | 36% | 34% | 32% | 28% | 27% | 28% | 38% | 32% | 36% | 26% |
| | temperature | | | | | | | | | | | | | |
| | dependence (−40° C. | | | | | | | | | | | | | |
| | to 80° C.) | | | | | | | | | | | | | |
| | Adhesion (N/mm) | 1.1 | 1 | 1.3 | 1.3 | 1.4 | 1.3 | 1.1 | 1 | 1.5 | 1.2 | 1 | 1.1 | 0.7 |
| | Gel fraction | 51% | 52% | 53% | 62% | 63% | 72% | 43% | 37% | 46% | 53% | 52% | 54% | 47% |
| | (mass %) | | | | | | | | | | | | | |

TABLE 4

| | | | Example | Example | Example | Example |
|---|---|---|---|---|---|---|
| | | | 27 | 28 | 29 | 30 |
| Monomer | Monomer Y | 2EHA | 18 | 18 | 18 | 10 |
| | | ISTA | 0 | 0 | 0 | 0 |
| | | IBXA | 0 | 0 | 0 | 10 |
| | Monomer X | NVP | 5 | 5 | 5 | 6 |
| | | NVC | 0 | 0 | 0 | 0 |
| | Other | M-140 | 0 | 0 | 0 | 0 |

| Cross-linking | NDA | 0 | 0 | 0 | 0 |
|---|---|---|---|---|---|
| agent | DPPA | 0 | 0 | 0 | 0 |
| | D110N | 0 | 0 | 0 | 0 |
| Rubber | Polyisobutylene | 0 | 0 | 0 | 0 |
| | Polyvest110 | 10 | 10 | 30 | 10 |
| | LBR305 | 0 | 0 | 0 | 0 |
| | LIR30 | 0 | 0 | 0 | 0 |
| | UC102 (including | 0 | 0 | 25 | 30 |
| | cross-linking group) | | | | |
| | UC203 (including | 15 | 15 | 0 | 0 |
| | cross-linking group) | | | | |
| Viscosity | CLEARON P85 | 0 | 0 | 0 | 0 |
| imparting agent | CLEARON P135 | 0 | 0 | 40 | 40 |
| Polymerization | AIBN | 0 | 0 | 0 | 0 |
| initiator | TPO | 0 | 3 | 3 | 3 |
| | Irg184 | 4 | 0 | 0 | 0 |
| Ratio of mass of monomer X to total | | 21.7 | 21.7 | 21.7 | 23.1 |
| monomer component (mass %) | | | | | |
| Ratio of mass of monomer Y to total | | 78.3 | 78.3 | 78.3 | 76.9 |
| monomer component (mass %) | | | | | |
| Amount of rubber component to total | | 48.1 | 49.0 | 45.5 | 36.7 |
| solid content of composition | | | | | |
| (mass %) | | | | | |
| Evaluation | Relative permittivity | 2.4 | 2.4 | 2.4 | 2.4 |
| | Relative permittivity | 5% | 5% | 5% | 5% |
| | temperature | | | | |
| | dependence (0° C. to | | | | |
| | 40° C.) | | | | |
| | Relative permittivity | 8% | 9% | 8% | 8% |
| | temperature | | | | |
| | dependence (−40° C. | | | | |
| | to 80° C.) | | | | |
| | Adhesion (N/mm) | 0.6 | 0.7 | 0.8 | 0.85 |
| | Gel fraction | 40% | 44% | 45% | 46% |
| | (mass %) | | | | |

As shown in Table 1, it was confirmed that in an aspect in which a predetermined pressure sensitive adhesive composition was used, desired effects could be obtained.

On the other hand, in a case of using the pressure sensitive adhesive composition of the comparative examples in which predetermined requires were not satisfied, desired effects could not be obtained.

Particularly, it was confirmed that the obtained values of the pressure sensitive adhesive sheets obtained in Examples 27 to 30 were as low as 8% even when the test temperature was changed to a range of −40° C. to 80° C. from the range of 0° C. to 40° C. in the relative permittivity temperature dependence test (relative permittivity temperature dependence (−40° C. to 80° C.)).

By applying the pressure sensitive adhesive sheets obtained in the examples to the position of the pressure sensitive adhesive sheet shown in FIG. 5A, capacitive touch panels were produced.

### EXPLANATION OF REFERENCES

12: pressure sensitive adhesive sheet

18: capacitive touch panel sensor

20: protective substrate

40: display device

50: aluminum electrode

100, 200: laminate for a touch panel

300, 400: capacitive touch panel

What is claimed is:

1. A pressure sensitive adhesive composition comprising:
a component selected from the group consisting of a polymer obtained by polymerizing a monomer component including 5 to 75 mass % of a monomer having a nitrogen atom-containing cyclic structure and 25 to 80 mass % of a (meth)acrylic monomer having an alkyl group with 3 to 22 carbon atoms at an ester end, a product of partial polymerization of the monomer component, and the monomer component; and
at least one rubber component selected from the group consisting of polyisoprene, polyisobutylene, and polybutadiene,
wherein the content of the rubber component is 1 to 50 mass % with respect to a total solid content.

2. The pressure sensitive adhesive composition according to claim 1,
wherein the alkyl group is linear or branched.

3. The pressure sensitive adhesive composition according to claim 2,
wherein the (meth)acrylic monomer includes a (meth)acrylic monomer having a linear alkyl group with 10 to 22 carbon atoms at an ester end.

4. The pressure sensitive adhesive composition according to claim 2,
wherein the (meth)acrylic monomer includes a (meth)acrylic monomer having a branched alkyl group with 3 to 9 carbon atoms at an ester end, and a (meth)acrylic monomer having a linear alkyl group with 10 to 22 carbon atoms at an ester end.

5. The pressure sensitive adhesive composition according to claim 1,
wherein the rubber component includes two different types of rubber component.

6. The pressure sensitive adhesive composition according to claim 1, further comprising:
a viscosity imparting agent.

7. The pressure sensitive adhesive composition according to claim 1,
wherein the number of ring members of the monomer having the nitrogen atom-containing cyclic structure is 5 to 8.

8. The pressure sensitive adhesive composition according to claim 1, wherein the rubber component includes a rubber having a cross-linking group.

9. The pressure sensitive adhesive composition according to claim 1, wherein the rubber component includes polybutadiene and at least one selected from the group consisting of polyisoprene, polyisobutylene, and polybutadiene each having a cross-linking group.

10. The pressure sensitive adhesive composition according to claim 1, further comprising:
a polyfunctional monomer.

11. A pressure sensitive adhesive sheet formed by using the pressure sensitive adhesive composition according to claim 1.

12. A pressure sensitive adhesive sheet comprising:
a polymer obtained by polymerizing a monomer component including 5 to 75 mass % of a monomer having a nitrogen atom-containing cyclic structure and 25 to 75 mass % of a (meth)acrylic monomer having an alkyl group with 3 to 22 carbon atoms at an ester end; and
at least one rubber component selected from the group consisting of polyisoprene, polyisobutylene, and polybutadiene,
wherein the content of the rubber component is 1 to 50 mass % with respect to a total mass of the pressure sensitive adhesive sheet.

13. The pressure sensitive adhesive sheet according to claim 12,
wherein the alkyl group is linear or branched.

14. The pressure sensitive adhesive sheet according to claim 13,
wherein the (meth)acrylic monomer includes a (meth)acrylic monomer having a linear alkyl group with 10 to 22 carbon atoms at an ester end.

15. The pressure sensitive adhesive sheet according to claim 13,
wherein the (meth)acrylic monomer includes a (meth)acrylic monomer having a branched alkyl group with 3 to 9 carbon atoms at an ester end, and a (meth)acrylic monomer having a linear alkyl group with 10 to 22 carbon atoms at an ester end.

16. The pressure sensitive adhesive sheet according to claim 12,
wherein the rubber component includes two different types of rubber component.

17. The pressure sensitive adhesive sheet according to claim 12,
wherein the rubber component includes polybutadiene and at least one selected from the group consisting of polyisoprene, polyisobutylene, and polybutadiene each having a cross-linking group.

18. The pressure sensitive adhesive sheet according to claim 2, further co p sing:
a viscosity imparting agent.

19. The pressure sensitive adhesive sheet according to claim 12,
wherein the number of ring members of the monomer having the nitrogen atom-containing cyclic structure is 5 to 8.

20. The pressure sensitive adhesive sheet according to claim 2,
wherein a gel fraction is 30 to 75 mass %.

21. A pressure sensitive adhesive film comprising:
the pressure sensitive adhesive sheet according to claim 12; and
a peelable sheet disposed on at least one surface of the pressure sensitive adhesive sheet.

22. A laminate for a touch panel comprising:
the pressure sensitive adhesive sheet according to claim 12; and
a capacitive touch panel sensor.

23. The laminate for a touch panel according to claim 22, further comprising:
a protective substrate,
wherein the protective substrate, the pressure sensitive adhesive sheet, and the capacitive touch panel sensor are provided in this order.

24. A capacitive touch panel comprising:
a capacitive touch panel sensor, the pressure sensitive adhesive sheet according to claim 12, and a display device in this order.
